(19) United States
(12) Patent Application Publication
(10) Pub. No.: US 2013/0299138 A1
(43) Pub. Date: Nov. 14, 2013

(54) COVER FOR TERMINAL BOX IN A RAM AIR FAN ASSEMBLY

(71) Applicants: Darryl A. Colson, West Suffield, CT (US); John M. Beck, Windsor, CT (US)

(72) Inventors: Darryl A. Colson, West Suffield, CT (US); John M. Beck, Windsor, CT (US)

(21) Appl. No.: 13/466,363

(22) Filed: May 8, 2012

(51) Int. Cl. F28D 15/00; B23P 6/00; F03B 11/02

(52) U.S. Cl. 165/104.34; 415/208.1; 29/888.021

(57) ABSTRACT

A terminal box cover for a ram air fan assembly includes a body defining a top wall having an outer surface. The body extends between a forward end and a rearward end. An opening is formed in a forward wall at the forward end. The opening allows electric supply feeders to move into an internal space defined by the cover when mounted on a terminal box base. The outer surface extends from the forward end to the rearward end such that the forward wall is thicker than a rear wall at the rearward end. The thickness is defined as a distance extending away from the top wall. A separator wall is defined extending from the inner surface. The separator wall extends from the front wall toward the rear wall, but is spaced from the rear wall. The separating wall has a curved inner lip at a rearwardmost end. In addition, a ram air fan assembly, a system including a heat exchanger, and a method of replacing a box cover are also described.

### BACKGROUND OF THE INVENTION

This application relates to a cover for an electric terminal box in a ram air fan assembly.

Modern aircraft require a source of air for a number of reasons. One source of air is required to cool a heat exchanger. Often, a ram air fan assembly is provided to drive air to cool the heat exchanger.

The ram air fan assembly requires a source of electricity, and further must receive control information. Typically, power electric wires and smaller control electric wires communicate to the fan assembly through a terminal box. The terminal box typically has a cover, enclosing a terminal box base.

The terminal box base and cover may include structure to separate the power wires and the control wires. In the past, the terminal box and cover have generally included a relatively straight extending separator wall.

### SUMMARY OF THE INVENTION

A terminal box cover for a ram air fan assembly includes a body defining a top wall having an outer surface. The body extends between a forward end and a rearward end. An opening is formed in a forward wall at the forward end. The opening allows electric supply feeders to move into an internal space defined by the cover when mounted on a terminal box base. The outer surface extends from the forward end to the rearward end such that the forward wall is thicker than a rear wall at the rearward end. The thickness is defined as a distance extending away from the top wall. A separator wall is defined extending from the inner surface. The separator wall extends from the front wall toward the rear wall, but is spaced from the rear wall. The separating wall has a curved inner lip at a rearwardmost end.

In addition, a ram air fan assembly, a system including a heat exchanger, and a method of replacing a box cover are also described.

These and other features of this application will be best understood from the following specification and drawings, the following of which is a brief description.

### BRIEF DESCRIPTION OF THE DRAWINGS

FIG. 1 shows a ram air fan assembly.

FIG. 2A is a cross-sectional view through a terminal box and the ram air fan.

FIG. 3 is a perspective view of the terminal box.

FIG. 4 is an inside view of a cover.

FIG. 5 is a cross-sectional view through the cover.

FIG. 6 is a view of an inner face of the cover

### DETAILED DESCRIPTION

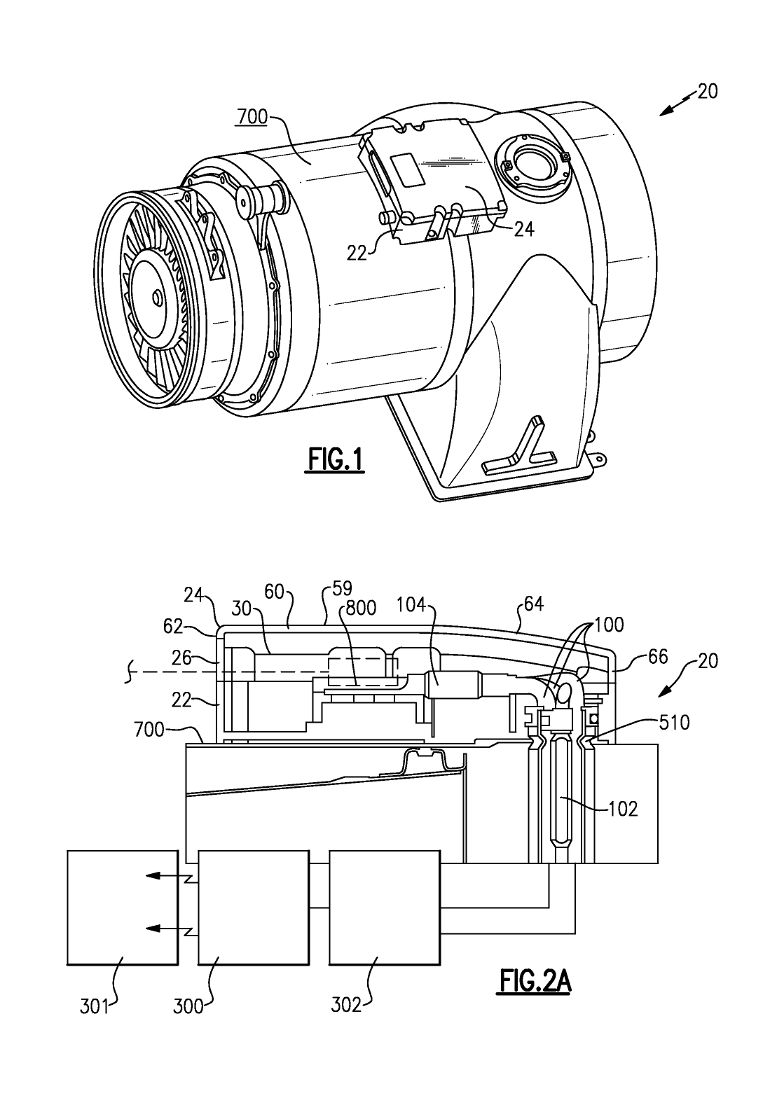

FIG. 1 shows a ram air fan assembly 20 such as may be utilized on aircraft. As known, a terminal box base 22 is attached to an outer housing 700 of the assembly, and serves as a way to communicate electrical power and control signals to the fan assembly. A terminal box cover 24 is formed of an appropriate plastic, and encloses an internal space. One acceptable plastic may be an appropriate polyetheretherketone (PEEK).

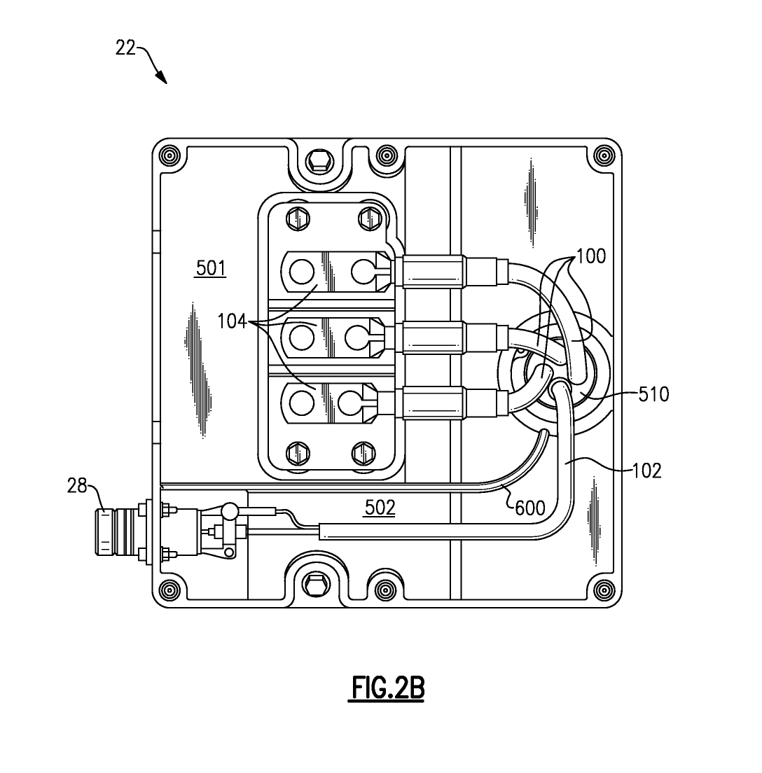

FIG. 2A is a cross-sectional view through the base 22 and cover 24. As shown, an opening 26 in cover 24 extends into an internal cavity 30. A top wall 59 of the cover 24 has a first forward end 60 spaced toward the opening 26 which is relatively flat, and a second rearward end 64 which can be seen to curve downwardly, such that a forward end wall 62 of the cover is thicker than an opposed rearward end wall 66. Thickness is defined as a dimension extending away from the top wall 59. As can be appreciated, the top wall 59 has an inner surface that will face toward the housing 700 of the ram air fan assembly, and an outer surface looking away from the outer housing 700, and serving to protect an internal space defined between the cover 24 and base 22.

Three motor power wires have terminals 104 that extend to a wire 100 that provides electric power to a fan motor 302. A control wire 102 can be seen to also extend to motor 302. Forward end 60 of top wall is generally associated with the position 800 where the power supply, shown in phantom, will be received. The curving rearward end 64 begins after this location, and provides a more compact overall arrangement. The fan motor 302 drives a fan assembly 300. The fan assembly 300 blows air over a heat exchanger 301, all as known. It should be understood that the power and control wires may also go to various components associated with the fan assembly 300, such as movable vanes, etc.

FIG. 2B shows internal structure of the base 22. This internal structure is the subject of co-pending U.S. patent application Ser. No. 13/398,113, entitled “Terminal Box Assembly,” and filed on Feb. 16, 2012. As can be appreciated, there are three power terminals 104 which communicate through wires 100 and through a grommet 510 to the fan motor. The control wires 102 also extends through the grommet 510. As can be appreciated, a separator wall 600 separates a space 502 receiving the control wire 102, and another space 501 including the power wires 100. The separator wall 600 serves to separate the wires as they extend within the base box.

As shown in FIG. 3, the opening 26 allows electric feeder wires to be attached to the terminal portions 104 to supply electric power from an outside source. A connection 28 receives a control connection to provide control signals to and from the wire 102.

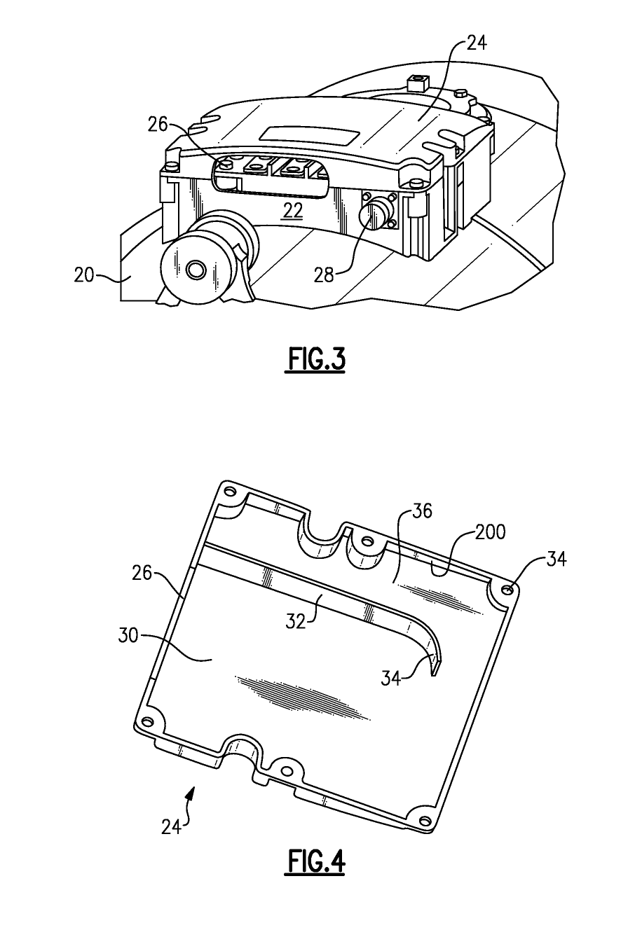

FIG. 4 is an internal view of the cover 24. As shown, a space 30 is aligned with the opening 26, and a separator wall 32 separates the space 36 from the space 30. Wall 32 mates over wall 600 in the base 22. The space 36 will receive the control wire (in combination with space 502) associated with the control port 28 and the space 30 (in combination with space 501) receives the power wires. As can be appreciated, the separator wall 32 has an inner curved lip 34 that curves away from a wall 200 that defines the space 36 along with the separating wall 32.

The use of the curved lip 34 provides continued separation between the power wires 100 and the control wire 102 compared to the prior art.

FIG. 5 is a cross-sectional view through the cover 24. As can be appreciated, the curved rear portion 64 of the top surface 59 results in a reduced thickness at rear wall 66. A thickness d₁ can be defined at the forward wall 62, and a thickness d₂ at the rear wall 66. In one embodiment, d₁ was 1.05 inches (2.67 centimeters) and d₂ was 0.600 inch (1.52 centimeters). In embodiments, a ratio of d₁ to d₂ would be between 1.45 and 2.05.

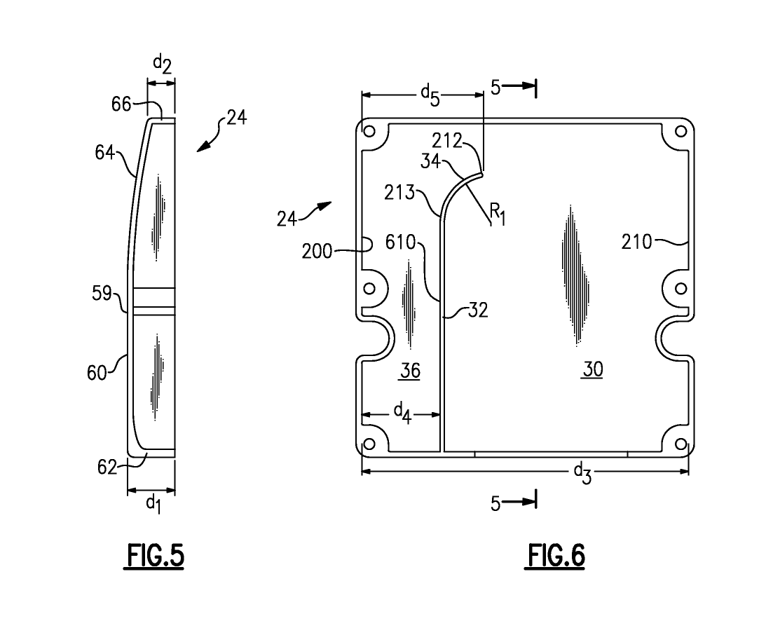

FIG. 6 shows the inner face of the cover 24. As can be seen, an overall width d₃ of the box can be defined between the inner side walls 200 and 210. Another width d₄ can be defined between the inner wall 200 and a side of the separator wall 32 at a straight portion 610 of the separator wall 32 that is parallel to wall 200, and before curved lip 34. Yet another distance d₅ can be defined between the inner wall 200 and a rearwardmost distant point 212 of the curved lip 34. Note rearwardmost end 212 is still spaced from rear wall 66 to provide space for the wire 102 to reach grommet 510.

In one embodiment, d₃ was 7.25 inches (18.4 centimeters), d₄ was 1.74 inches (4.42 centimeters) and d₅ was 2.71 inches (6.88 centimeters). In embodiments, a ratio of d₅ to d₃ was between 0.355 and 0.390, and a ratio of d₄ to d₅ was between 0.590 and 0.690.

The distance d₃ may be called a “width” of the cover 24. The distance d₄ may be called the “spacing distance” and the distance d₅ may be called a “rearward end distance.”

As can be seen, the lip 44 curves about a radius R₁ from a beginning point 213 to an end point 212.

In one embodiment, R₁ was 1.04 inches (2.64 centimeters). In embodiments, R₁ was between 1.00 inches (2.54 centimeters) and 1.07 inches (2.72 centimeters). In embodiments, a ratio of R₁ to d₅ is between 0.365 and 0.425.

Although an embodiment of this invention has been disclosed, a worker of ordinary skill in this art would recognize that certain modifications would come within the scope of this invention. For that reason, the following claims should be studied to determine the true scope and content of this invention.

1. A terminal box cover for a ram air fan assembly comprising:
a body defining a top wall having an outer surface and an inner surface, with said body extending between a forward end and a rearward end;
an opening formed in a forward wall at said forward end, said opening allowing electric supply feeders to move into an internal space defined by said cover when mounted on a terminal box base;
said outer surface extending from said forward end to said rearward end such that said forward wall is thicker than a rear wall at said rearward end, thickness being defined as a distance extending away from said top wall; and
a separator wall defined extending from said inner surface, said separator wall extending from said front wall toward said rear wall, and being spaced from said rear wall, and said separating wall having a curved inner lip at a rearwardmost end.

2. The cover as set forth in claim 1, wherein said curved inner lip curves about a radius that is between 1.00 and 1.07 inches (2.54 and 2.72 centimeters).

3. The cover as set forth in claim 1, wherein said rearwardmost end of said curved inner lip is spaced from an inner surface of a first sidewall that is closest to said rearward most end by a rearward end distance, and a ratio of said radius of curvature to said rearward end distance is between 0.365 and 0.425.

4. The cover as set forth in claim 3, wherein a ratio of the thickness of said forward wall to a thickness of said rear wall is between 1.45 and 2.05.

5. The cover as set forth in claim 4, wherein a width is defined between said first sidewall and an opposed side wall, a ratio of said rearward end distance to said width being between 0.355 and 0.390.

6. The cover as set forth in claim 5, wherein a spacing distance is defined between said first sidewall and said separating wall, with a ratio of said spacing to said distance being between 0.590 and 0.690.

7. A ram air fan comprising:
an outer housing enclosing a fan, and a fan motor, said fan motor receiving power supply wires, and a control wire;
a terminal box mounted on said outer housing, said terminal box including a base defining an internal space, and a terminal box cover enclosing said space by being attached to said base, said power supply wires and said control wire extending from said terminal box to communicate with at least said fan motor;
said cover defining a top wall having an outer surface and an inner surface, with said body extending between a forward end and a rearward end, an opening formed in a forward wall at said forward end, said opening allowing electric supply feeders to move into said internal space, said outer surface extending from said forward end to said rearward end such that said forward wall is thicker than a rear wall at said rearward end, thickness being defined as a distance extending away from said top wall; and
a separator wall defined extending from said inner surface, said separator wall extending from said front wall toward said rear wall, and being spaced from said rear wall, and said separating wall having a curved inner lip at a rearwardmost end.

8. The fan as set forth in claim 7, wherein said curved inner lip curves about a radius that is between 1.00 and 1.07 inches (2.54 and 2.72 centimeters).

9. The fan as set forth in claim 7, wherein said rearwardmost end of said curved inner lip is spaced from an inner surface of a first sidewall that is closest to said rearwardmost end by a rearward end distance, and a ratio of said radius of curvature to said rearward end distance is between 0.365 and 0.425.

10. The fan as set forth in claim 9, wherein a ratio of the thickness of said forward wall to a thickness of said rear wall is between 1.45 and 2.05.

11. The fan as set forth in claim 10, wherein a width is defined between said first sidewall and an opposed sidewall, with a ratio of rearward end distance to said width being between 0.355 and 0.390.

12. The fan as set forth in claim 11, wherein a spacing distance is defined between said first sidewall and said separating wall, with a ratio of said spacing distance to said rearward end distance is between 0.590 and 0.690.

13. A system including a heat exchanger comprising:
a heat exchanger to be cooled a ram air fan assembly;
the ram air fan assembly including an outer housing enclosing a fan, and a fan motor, said fan motor receiving power supply wires, and a control wire;
a terminal box mounted on said outer housing, said terminal box including a base defining an internal space, and a terminal box cover enclosing said space by being attached to said base, said power supply wires and said control wire extending from said terminal box to communicate with at least said fan motor;
said cover defining a top wall having an outer surface and an inner surface, with said body extending between a forward end and a rearward end, an opening formed in a forward wall at said forward end, said opening allowing electric supply feeders to move into said internal space, said outer surface extending from said forward end to said rearward end such that said forward wall is thicker than a rear wall at said rearward end, thickness being defined as a distance extending away from said top wall; and
a separator wall defined extending from said inner surface, said separator wall extending from said front wall toward said rear wall, and being spaced from said rear wall, and said separating wall having a curved inner lip at a rearwardmost end.

14. The system as set forth in claim 13, wherein said curved inner lip curves about a radius that is between 1.00 and 1.07 inches (2.54 and 2.72 centimeters).

15. The system as set forth in claim 13, wherein said rearwardmost end of said curved inner lip is spaced from an inner surface of a first sidewall that is closest to said rearwardmost end by a rearward end distance, and a ratio of said radius of curvature to said rearward end distance is between 0.365 and 0.425.

16. The system as set forth in claim 16, wherein a ratio of the thickness of said forward wall to a thickness of said rear wall is between 1.45 and 2.05.

17. The system as set forth in claim 16, wherein a width is defined between said first sidewall and an opposed sidewall, with a ratio of said rearward end distance to said width being between 0.355 and 0.390.

18. The system as set forth in claim 17, wherein a spacing distance is defined between said first sidewall and said separating wall, with a ratio of said spacing distance to said rearward end distance being between 0.590 and 0.690.

19. A method of replacing a terminal box cover comprising the steps of:
removing a terminal box cover from a terminal base, said terminal base having a separating wall for separating a space receiving a control wire, and another space receiving power wires, and said separator wall on said terminal base having a curved rearwardmost end spaced from a forward wall through which said power wires and said control wires will be connected to outside wires, and replacing the removed terminal box cover with a new terminal box cover; and
said new terminal box cover having:
a body defining a top wall having an outer surface and an inner surface, with said body extending between a forward end and a rearward end;
an opening formed in a forward wall at said forward end, said opening allowing electric supply feeders to move into said internal space defined by said cover when mounted on a terminal box base;
said outer surface extending from said forward end to said rearward end such that said forward wall is thicker than a rear wall at said rearward end, thickness being defined as a distance extending away from said top wall; and
a separator wall defined extending from said inner surface, said separator wall extending from said front wall toward said rear wall, and being spaced from said rear wall, and said separating wall having a curved inner lip at a rearwardmost end.

20. The method as set forth in claim 19, wherein the new terminal box cover has said curved inner lip curves about a radius that is between 1.00 and 1.07 inches (2.54 and 2.72 centimeters), said rearwardmost end of said curved inner lip is spaced from an inner surface of a sidewall that is closest to said rearward most end by a rearward end distance, and a ratio of said radius of curvature to said rearward end distance is between 0.365 and 0.425, a ratio of the thickness of said forward wall to a thickness of said rear wall is between 1.45 and 2.05, a width defined between said first sidewall and a second sidewall, and with a ratio of said rearward end distance to said width being between 0.355 and 0.390, and a spacing distance defined between said first sidewall and said separating wall, and a ratio of said spacing distance to said rearward end distance is between 0.590 and 0.690.
